(19) United States
(12) Patent Application Publication
(10) Pub. No.: US 2024/0425332 A1
(43) Pub. Date: Dec. 26, 2024

(54) DEVICE FOR MONITORING A CONSTRUCTION SITE

(71) Applicant: BUILDAI PTY LTD, Lavender Bay, NSW (AU)

(72) Inventor: Kristian Butcher, Manly Vale, NSW (AU)

(21) Appl. No.: 18/709,733

(22) PCT Filed: Nov. 12, 2022
(86) PCT No.: PCT/AU2022/051356

§ 371 Date: May 13, 2024

(30) Foreign Application Priority Data
Nov. 12, 2021 (AU) 2021903629

(51) Int. Cl. B66D 3/26; B66C 1/12; B66C 13/44; B66C 15/06

(52) U.S. Cl. CPC B66D 3/26; B66C 1/125; B66C 13/44; B66C 15/065

(57) ABSTRACT

The invention is broadly directed to a crane mounted device for monitoring a construction site, the device comprising a housing for containing monitoring equipment, the housing configured to be releasably secured via clamping means to a hoist of the crane above an object to be lifted, the housing locatable about the hoist to have line-of-sight along the hoist and to the object to be lifted wherein, in use, a weight of the housing is wholly supported by the hoist via the clamping means while the weight of the object is transferred via the hoist directly to the crane, such that the weight of the object bypasses the housing.

### FIELD OF THE INVENTION

The invention relates to devices for monitoring construction sites. Specifically, although by no means exclusively, the invention relates to devices for monitoring a construction site that are suspended from cranes or other devices that lift or hoist objects.

### BACKGROUND TO THE INVENTION

Cranes are often deployed on construction sites to move objects from one location, usually ground level, to another location, usually above ground level. Cranes typically comprise a tower and a load jib. The tower comprises a first end and a second end, the first end is usually fixed to a structure (i.e. the ground or a floor of a building) and the second end is usually pivotably connected to the load jib. The load jib usually comprises a cab for an operator and a hoist for lifting the object. The hoist is a mechanism for lifting and lowering the object. The hoist typically includes a counter-weight, a moveable trolley, pulleys, a hoist line, hook block and a hook.

A problem with these cranes is that the cab is normally situated high (i.e. 10 m to 100 m) above the construction site which makes visibility of the construction site difficult for the operator situated in the cab.

To address this issue, construction site personnel may describe and relay what they see and hear at the construction site to the operator in the cab using handheld radios, i.e. walkie talkies. This method is less than ideal because there is often communication lost or miscommunication. The operator is more likely to make a mistake if they do not have correct and/or up-to-date information about the construction site. A mistake can result in a serious accident which may injure or kill personnel or damage property.

Devices have been developed that monitor the construction site; containing monitoring equipment, such as a camera, a controller and a transmitter, and are often suspended from the hoist line proximal to the hook. The camera feed is processed in the controller and fed to the operator via a transmitter to enable them to monitor the construction site. However, these devices suffer from a number of problems:

First, they are typically very heavy-in the order of 700 kg to 1,100 kg. The payload limit of the crane is fixed and therefore any weight added to the hoist line significantly limits the maximum load that can be carried by the crane.

Secondly, they are difficult to remove and mount to the hoist line as they often require a number of persons and specialised equipment. This adds time, complexity and ultimately cost to the construction project.

Thirdly, they need to be robust enough to protect the monitoring equipment from the environment. This includes being robust enough to survive frequent impacts against objects and being able to function in all weather conditions.

It is desirable to provide a device for monitoring a construction site that ameliorates at least one of the above disadvantages or at least provides the user with a useful alternative.

It is to be understood that, if any prior art publication is referred to herein, such reference does not constitute an admission that the publication forms a part of the common general knowledge in the art, in Australia or any other country.

### SUMMARY OF THE INVENTION

The invention is broadly directed to a device for monitoring a construction site, the device having a housing for containing monitoring equipment, the housing configured to be releasably secured to a hoist of a crane for lifting an object, such that the housing has a line-of-sight view of the object from the hoist and the weight of the object is transferred to the crane without being supported by the crane.

In one embodiment, the invention provides a crane mounted device for monitoring a construction site, the device comprising a housing for containing monitoring equipment, the housing configured to be releasably secured via clamping means to a hoist of the crane above an object to be lifted, the housing locatable about the hoist to have line-of-sight along the hoist and to the object to be lifted wherein, in use, a weight of the housing is wholly supported by the hoist via the clamping means while the weight of the object is transferred via the hoist directly to the crane, such that the weight of the object bypasses the housing.

It is understood that the term bypass in this context refers to the weight of the object being transferred through or around the housing without the housing supporting the weight of the object.

Unlike devices known in the art which act as an intermediary component of the hoist line and effectively suspend the object from the housing, the housing of the present invention is configured to be releasably secured to the hoist such that the weight of the object is transferred to the crane without loading, effectively bypassing, the housing.

In some embodiments, there is provided a device for monitoring a construction site, the device having a housing for containing monitoring equipment, the housing configured to be releasably secured to a hoist line of a crane for lifting a physical object, wherein the housing is configured to allow the hoist line to extend through the housing such that, in use, the weight of the physical object is supported by the crane. Essentially, in this embodiment the hoist line extends through the housing such that the housing does not support any weight of the object to be lifted.

Because the housing of the invention is not required to be structurally strong enough to support the full weight of the object, the amount of material in the housing can be significantly reduced. Therefore, an advantage may be a device that has a significantly reduced weight compared to that necessary to support the full weight of the object. Minimising the weight of the housing may optimise the maximum load that can be carried by the crane. An additional advantage may be that users of the device retain confidence in the load carrying capacity of the crane, as the device itself does not carry the object.

For example, a crane with a 5,000 kg payload limit and a device that weighs 50 kg would be able to carry a maximum load of 4,950 kg. In contrast, the same crane with a device known in the art that weighs 700 kg would only be able to carry a maximum load of 4,300 kg. As such, in this example, the embodiments herein may allow for ˜10-20% more load to be carried by the crane.

The housing may have a mounting arrangement comprising a first clamping element and a second clamping element, with the first and second clamping elements being configured to be connected together in engagement with the hoist.

An advantage to this mounting arrangement may be that the housing may be removable from the hoist whilst the crane supports the object. This enables ease of removal and replacement of the device as it negates the requirement of specialised lifting equipment to support the object during removal and replacement of the device.

The housing may be connected to any part of the hoist that allows line of sight view of the object from the hoist.

In one embodiment, the housing may be configured to be releasably secured to a hook block on the hoist of the crane. The hook block is an assembly to which the hook is attached. The hook block may comprise a pair of plates connected together in a spaced apart arrangement to define a gap. The plates may be connected together via one or fastening elements, i.e. a bolt or a pin. The hook may be attached, pivotably or otherwise fixed, to at least one of the plates. The hook may be located within the gap between the plates.

In this embodiment, the first and second clamping element may be configured to be connected together in engagement with a mounting point on the hook block. The mounting point may be a fastening element such as a bolt or a pin.

The hook block may comprise an array of fastening elements and the housing may be configured, i.e. shaped and sized, so as to at least partly fit within a perimeter defined by the array within the gap defined by the plates. The housing may be configured, i.e. shaped and sized, so as the entirely fit within the perimeter defined by the array within the gap defined by the plates.

In another embodiment, the housing may be configured to be releasably secured to a hoist line on the hoist of the crane.

In this embodiment, the first and second clamping elements may be configured to be connected together in engagement with the hoist line.

The mounting arrangement may comprise a base that receives a locking pin. The locking pin may extend through an opening in a chain link to secure the base to the hoist line.

The mounting arrangement may comprise an aperture for receipt of the hoist line.

The aperture may be a slot that is configured for receipt of an element of the hoist line, for example a chain link, and orientated such that an adjacent element of the hoist line, for example an adjacent chain link, is prevented from passing therethrough.

Suitably, the slot may be rotationally orientated out of phase with the profile of the adjacent chain such that the adjacent chain link of the hoist line is prevented from passing therethrough. The slot may be rotationally oriented 5 to 175 degrees out of phase with a profile of the adjacent chain link. More suitably, the slot may be rotationally oriented 45 to 105 degrees out of phase with a profile of the adjacent chain link. Most suitably, the slot may be rotationally oriented 90 degrees out of phase with a profile of the adjacent chain link.

The housing may comprise a shell that is releasably secured to the mounting arrangement. The shell may be releasably secured by any means known in the art, for example via an interference fit or with the use of fasteners.

The shell may cover the mounting arrangement.

The shell may cover the monitoring equipment. An advantage to the shell covering the monitoring equipment may be that the shell shields the monitoring equipment from the external environment.

The shell may have a unitary construction. An advantage of a unitary construction may be that it eliminates gaps between adjoining components which may allow water and other contaminants to enter into the housing and affect the performance of and/or damage the monitoring equipment. However, it is also envisaged that the shell may comprise a plurality of shell components that are interconnectable to form the shell.

The shell may be made from any material that is suitably resistive to impact forces and weather conditions. The shell may be metallic. The shell may be a polymer. The shell may be a plastic or reinforced plastic material. Preferably, the shell is a waterproof material.

In one embodiment, the shell may be made from a polymeric material. Suitably, the polymeric material may be a die cast polymer. The applicant has found that making the shell from polymeric material results in a suitably reduced weight of the device whilst providing adequate strength and resilience to withstand frequent impacts against objects.

Examples of suitable die cast polymers may include: polyurethane; polypropylene; nylon; low-density polyethylene (LDPE); high-density polyethylene (HDPE); acrylonitrile butadiene styrene (ABS); polyoxymethylene (POM); and high-impact polystyrene (HIPS). In one implementation, Polyurethane 60 Shore A can be utilised.

The polymeric material may include reinforcing elements. These elements may be fibre filaments. Suitable fibre filaments may include carbon fibre, glass fibre or synthetic fibres such as aramids (i.e. Kevlar®).

For some applications, the shell may be made from metallic material, for example steel. The metallic material may be coated, for example painted or galvanised, with a weather resistant coating.

In some embodiments, the weight of the device may be between 30-150 kg. Preferably, the weight of the device is between 40-100 kg. More preferably, the weight of the device is between 50-70 kg.

The housing may comprise a platform for supporting monitoring equipment. Suitably, the platform is an internal platform within the housing. Suitably, the monitoring equipment may be mounted to the platform. The mounting of monitoring equipment may be by any means known in the art, for example via fasteners (i.e. screws, bolts or rivets), adhesives or hook and loop elements (i.e. Velcro®).

The platform may have a plurality of tiers that are axially spaced apart along an axis defined by the device. The platform may have a first tier and a second tier that are axially spaced apart along an axis defined by the device. Suitably, the first tier is a lower tier and the second tier is an upper tier. Additional tiers may be incorporated into the platform providing support for additional monitoring equipment within the device.

The monitoring equipment may comprise one or more electronic components, for example selected from any one or more of: environmental sensor(s); battery; controller; transmitter; and receiver.

The environmental sensor(s) may be selected from any one or more of: noise sensor; dust sensor; temperature sensor; wind sensor; Light Detection and Ranging (LIDAR) sensor; altimeter; Global Positioning System (GPS) sensor; accelerometer; and camera.

At least one environmental sensor may be a camera. Suitably, at least one camera may be downward facing thereby, in use, providing a view of an area directly below the device. Optionally, there may be multiple downward facing cameras. At least one camera may comprise a fisheye lens. Optionally, one or more upward facing cameras can be provided, for example, mounted on an upper surface of the shell. In an implementation, at least one camera corresponds to a hemisphere camera (i.e. a camera having a wide-angle view encompassing substantially an entire hemisphere). For example, the hemisphere camera may be an AXIS™ M3058-PLVE Network Camera.

In an optional arrangement, environmental sensor(s) are confined for location within a horizontal perimeter of the housing (e.g. for a substantially cylindrical shell, within the circumference of the shell). Advantageously, such a limitation ensures that the risk of damage, due to a swinging motion of the hoist (e.g. a chain or cable) to the environmental sensor(s) is reduced or removed. One or more cameras can be arranged for viewing in a horizontal direction, or in part, while being mounted within said horizontal circumference.

The battery may comprise a plurality of discrete units. Suitably, each discrete unit may be removable from the device, for example, to replace or recharge the unit.

The transmitter and receiver may enable wireless communications with one or more base stations.

The controller may be in direct or wired data communication with a camera located for viewing the area below the hook of the crane (herein, “hook camera”), such as to control the hook camera to obtain image data captured by the hook camera. The controller may also be in wireless data communication with a wireless data receiver located at a distal end of a jib of the crane, and the controller may be configured to communicate the image data captured by the hook camera to the wireless data receiver.

The invention also provides a method of installing the device as previously described on a crane, the method involving releasably securing the housing to the hoist of the crane such that the housing has a line of sight view of the object from the hoist and the weight of the object is transferred to the crane without being supported by the housing. In some embodiments, the housing may be mounted to a hoist line, such that the hoist line extends through the housing. In some embodiments the housing may be mounted to a hook block of the hoist.

The invention also provides a method of installing the device, as previously described, on a crane, the method involving: releasably securing the first and second clamping element to the hoist line and releasably securing the shell to the mounting arrangement.

In the context of this specification, terms such as “upper” and “lower” refer to the positions on the device as oriented when in use, for example when suspended from a hoist of a crane.

The invention also provides a visualising system for providing a view of an area underneath a hook of a crane, said crane comprising a cab and a jib extending away from the cab, and a hoist comprising a hoist line for hoisting a load located below a distal end of the jib, wherein the hook is located at an end of the hoist line distal to the jib, wherein the system comprises: the device as described above; the hook camera, positioned for viewing the area below the hook of the crane; the wireless data receiver positioned at or near the distal end of the jib; and a receiver unit located in or proximal to the cab and in wired data communication with the wireless data receiver, wherein the receiver unit receives images captured by the hook camera via data communication between it and the controller, the data communication including a wireless data communication between the controller and the wireless data receiver and a wired data communication between the wireless data receiver and the receiver unit, and wherein the receiver unit is configured to display to a crane operator within the cab the images captured by the hook camera and communicated to the receiver unit by the controller.

An advantage of the visualising system may be that it negates the requirement of a wired connection between the hook and the jib. The distance between the hook and the jib is variable which means that wires can become slack when the distance between the hook and the jib are reduced. It is desirable to avoid slack wires as they may snag on structures and objects at the construction site.

A further advantage of the visualising system may be that the combination of wireless communication and wired communication allows for low latency data transfer when compared with visualising systems that are fully wireless.

The wireless connection may allow for line-of-sight wireless data communication between the controller and the wireless data receiver.

In the context of this specification, the term “hoist” should be construed as a mechanism for lifting and lowering the object. That hoist may comprise a counter weight, a moveable trolley, pulleys, a hoist line, hook block and a hook.

The term “object” should be given its plain meaning, i.e. a material thing that can be seen and touched and has material properties such as weight.

In the context of this specification, the term “releasably secured” should be given its plain meaning of being capable of being selectively attached to the hoist line, being capable of being selectively detached from the hoist line and being capable of being selectively reattached to the hoist line.

In the context of this specification, the term “monitoring equipment” includes any device and/or system (mechanical or electrical) that allows information about the construction site to be relayed to an operator located remotely. The operator may be a person or another device such as a computer.

In the context of this specification, the term “hoist line” includes flexible lifting elements such as cables and chains.

In the context of this specification, the term “extends through” means to extend completely from one end of the housing to another end of the housing such that the full weight of the physical object is not supported by the housing.

The term “construction site” refers to any location in which work such as construction, demolition or manufacturing, including material loading or unloading, is taking place. Examples of construction sites include: residential building sites; commercial building sites; factories; power stations; mine sites; warehouses; ports; and loading bays.

The term “location” includes at ground level, above ground level and below ground level.

The term “monitoring” refers to visualising objects around the construction site and/or measuring aspects of the construction site. These aspects may include environmental conditions such as windspeed, temperature, barometric pressure or noise level. Aspects may also include conditions of objects in the construction site such as distance between objects, speed of objects, and acceleration of objects.

As used herein, the word “comprise” or variations such as “comprises” or “comprising” is used in an inclusive sense, i.e. to specify the presence of the stated features but not to preclude the presence or addition of further features in various embodiments of the invention.

### BRIEF DESCRIPTION OF THE DRAWINGS

In order that the invention may be more clearly understood, embodiments will now be described, by way of example, with reference to the accompanying drawings, in which:

FIG. 1 is a device according to an embodiment of the invention, in which the housing is releasably secured to a hoist line of a crane;

FIG. 2 is a bottom perspective view of a device according to another embodiment of the invention; the housing is shown to be transparent for illustrative purposes to show the internal components within the housing;

FIG. 3 is a bottom perspective view of the device shown in FIG. 2 rotated about the hoist line by approximately 90 degrees, illustrating first and second clamping elements forming a mounting arrangement of the device;

FIG. 4 is a top perspective view of the device shown in FIG. 2, illustrating a selection of monitoring equipment mounted on the mounting arrangement;

FIG. 5 is a top perspective view of the device shown in FIG. 3, illustrating an uppermost surface for mounting antennae;

FIG. 6a is a sectional view of a first clamping element of the mounting arrangement of the device shown in FIGS. 1-5;

FIG. 6b is a sectional view of a second clamping element of the mounting arrangement of the device shown in FIGS. 1-5;

FIG. 7 is a sectional view of the mounting arrangement shown in FIG. 8 along the line X-X, wherein a first portion of the section comprises the first clamping element and a second portion of the section comprises the second clamping element;

FIG. 8 is a top view of the mounting arrangement shown in FIGS. 6 and 7 formed from the first and second clamping elements;

FIG. 9 is a schematic view of a lower platform of the mounting arrangement shown in FIG. 6-8;

FIG. 10 is a schematic view of an upper platform of the mounting arrangement shown in FIGS. 6-8;

FIG. 11 is a schematic view of a lower platform of an alternative mounting arrangement of the device;

FIG. 12 is a schematic view of an upper platform of the alternative mounting arrangement of the device from FIG. 11;

FIG. 13 is a schematic view of a visualisation system according to an embodiment of the invention;

FIG. 14 is a perspective view of a device according to an alternative embodiment, in which a housing is configured to be releasably secured to a hook block of a crane;

FIG. 15 is a perspective view of the device shown in FIG. 14 with a compartment door in an open position showing internal components within the housing;

FIG. 16 is a perspective view of an assembly comprising the device, as shown in FIGS. 14 and 15, releasably secured to the hook block, with the housing cut away for illustrative purposes in order to show the internal components, such as a platform within the housing;

FIG. 17 is a side view of the assembly shown in FIG. 16, illustrating an end block mounted on an opposing side of the housing to the compartment door;

FIG. 18 is a top view of the platform for mounting and supporting monitoring equipment as shown in FIGS. 16 and 17;

FIG. 19 is a sectional view of the platform in FIG. 18, taken along the line A-A, illustrating downward facing cameras at opposing ends of the platform and a controller centrally mounted thereto;

FIG. 20 is a front view of the housing of the device as shown in FIGS. 14 and 15, illustrating opening for the downwardly facing cameras to provide line-of-sight to the hoist or hook below; and

FIG. 21 is a sectional view of the housing of FIG. 20, taken along the line B-B, illustrating a pair of clamps for mounting the housing to the hook block.

### DESCRIPTION OF EMBODIMENTS

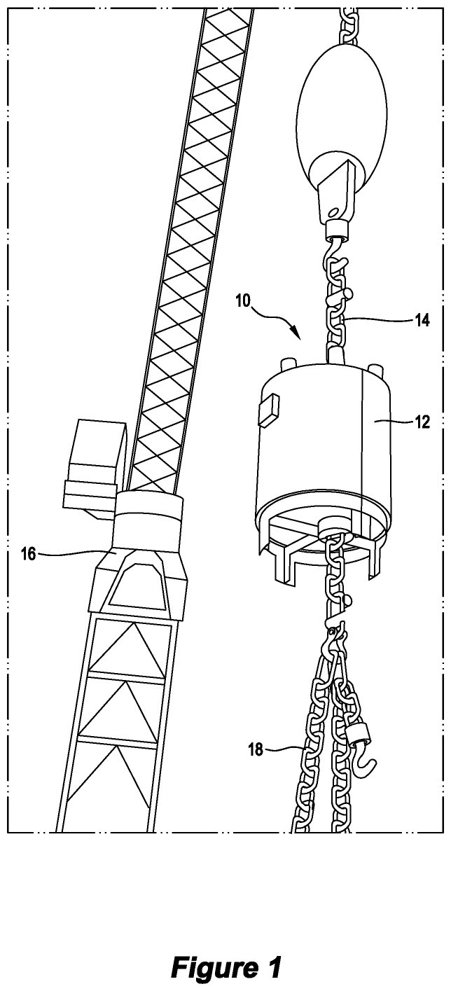

FIG. 1 shows a device 10 for monitoring a construction site. The device 10 comprises a housing 12 for containing monitoring equipment. The housing 12 is configured to be releasably secured to a hoist line of a crane 16 for lifting an object 18. In FIG. 1, the hoist line is illustrated as a chain 14. The housing 12 is located to have direct view of the object from the hoist line: accordingly, the housing has line-of-sight of the object. The housing 12 is configured to allow the chain 14 to extend through the housing such that, in use, the weight of the object 18 is transferred to the crane 16 via the hoist line without transferring load to or through the housing 12.

In this configuration, the housing does not bear any load from the hoist line. And because the housing 12 does not support the weight of the object 18 it is not required to withstand the forces, i.e. shear and bending forces, resulting from supporting the full weight of the object 18. With this arrangement the amount of material required to maintain structural integrity of the housing 12, during normal operation, is minimal or at least substantially reduced when compared to devices known in the art. Minimising the weight of the housing 12 (and the device 10) increases the maximum load that can be carried by the crane 16.

For example, a crane with a 5,000 kg payload limit and a device 10 that weighs 50 kg would be able to carry a maximum load of 4,950 kg. In contrast, the same crane with a device known in the art that weighs 700 kg would only be able to carry a maximum load of 4,300 kgs. As such, the present invention can allow for approximately 10-20% more load to be carried by the crane.

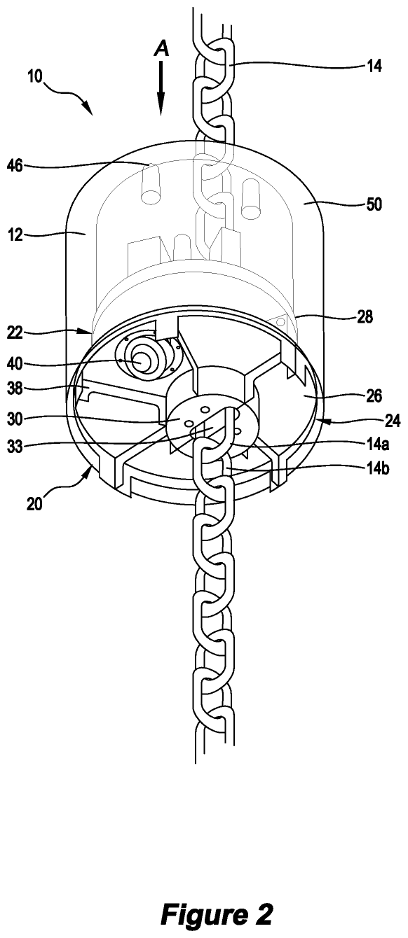

As shown in FIGS. 2-5, the device 10 comprises a housing 12 for containing monitoring equipment. The housing 12 comprises a steel mounting arrangement 20 for releasably securing the device 10 to the chain 14 and for mounting monitoring equipment thereto. The housing 12 also comprises a polymeric outer shell 50 for releasably securing to the mounting arrangement 20 to cover the monitoring equipment.

The mounting arrangement 20 comprises a first clamping element 22 and a second clamping element 24.

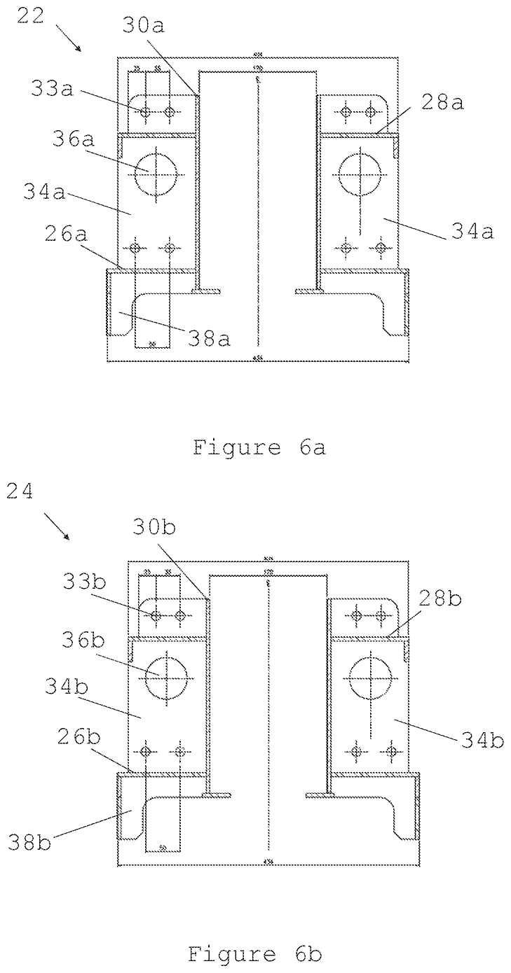

Turning to FIGS. 6a and 6b, each of the first and second clamping elements 22, 24 comprise a pair of webs 34a, 34b which extend between the lower tiers 36 and upper tiers 28 on each side of the respective clamping elements 22, 24. As shown in FIGS. 6a, 6b each of webs 34a, has four holes 33a that are alignable with corresponding holes 33b in each of the webs 34b of the opposing clamp when the clamping elements 22, 24 are mated together to define the mounting arrangement 20.

FIGS. 6a and 7 show the first clamping element 22 comprising an axial section 30a. The axial section has a semi-circular side wall 31a with upper and lower ends 32a projecting from the side wall 31a to define a cavity 33.

A pair of flanges 26a and 28a project from the axial section 30a. Both the flanges 26a, 28a have a semi-circular cross-section when viewed in plan view. The pair of flanges 26a, 28a are axially spaced from each other along the axial section 30a to define a space 37a therebetween. The first clamping element 22 further comprises a pair of webs 34a that project from the axial section 30a and extend across the space 37a to connect the pair of flanges 26a, 28a.

Each web 34a has a first set of holes 33a arranged in a square array on the web 34a for receiving a fastening means (as will be explained later in the specification). Each web 34a also has a hole 36a positioned within a perimeter defined by the first set of holes 33a.

The hole 36a is configured for routing cables and/or allowing airflow therethrough.

FIGS. 6b and 7 show the second clamping element 24 comprising an axial section 30b. The axial section has a semi-circular side wall 31b with upper and lower end walls 32b projecting from the side wall 31b to define the cavity 33. A pair of flanges 26b and 28b project from the axial section 30b. Both the flanges 26b, 28b have a semi-circular cross-section when viewed in plan view. The pair of flanges 26b, 28b are axially spaced from each other along the axial section 30b to define a space 37b therebetween. The second clamping element 24 further comprises a pair of webs 34b that project from the axial section 30a and extend across the space 37b to connect the pair of flanges 26b, 28b.

Each web 34b has a first set of holes 33b arranged in a square array on the web 34b for receiving a fastening means (as will be explained later in the specification). Each web 34b also has a hole 36b positioned within a perimeter defined by the first set of holes 33b.

The hole 36b is configured for routing cables and/or allowing airflow therethrough.

As shown in FIGS. 6a,6b, an underside of the lower tier 26 provides a plurality of reinforcement ribs 38a, 38b. The ribs 38a, 38b radiate outwardly from the central hub 30 like spokes providing reinforcement to the lower tier 26. The reinforcement ribs 38 increase the stiffness of the lower tier 26 and improve the resistance to impact of device 10.

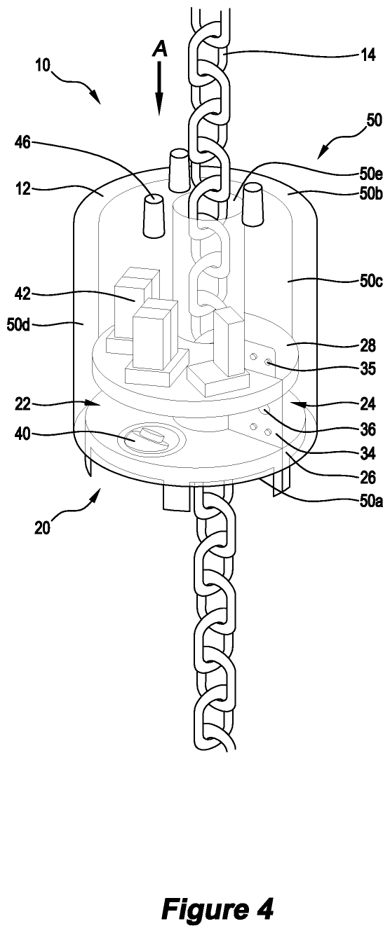

As shown in the sectional view of FIG. 7, the first clamping element 22 is larger than the second clamping element 24. As shown in FIGS. 4-5 and 8, the aligned holes 33a,33b are configured for receipt of fasteners, bolts 35, which can be used to secure the first and second clamping elements 22, 24 together by threading nuts onto threaded ends of the bolts 35. When joined together, by placing fasteners 35 through the holes 33a, 33b to join the respective webs 34a, 34b the central cavity 33 formed is cylindrical in shape.

When viewed in plan, the first clamping element 22 and second clamping elements 24 together form a circular cross-section. As the first and second clamping elements are joined they form: a substantially circular lower tier 26; a substantially circular upper tier 28; and a central hub 30 that axially spaces the lower and upper tiers 26, 28 apart from each other to define the annular space 37a,37b therebetween. The lower and upper tiers 26, 28 provide platforms for mounting and supporting monitoring equipment as will be discussed later in this specification.

In the arrangements shown in FIGS. 2 to 10, the first clamping element 22 and second clamping element 24 have non-identical cross-sections (e.g. when viewed from above as shown by arrow A in FIGS. 2-5). In particular, the first clamping element 22 can have a larger overall cross-sectional profile compared to the second clamping element 24.

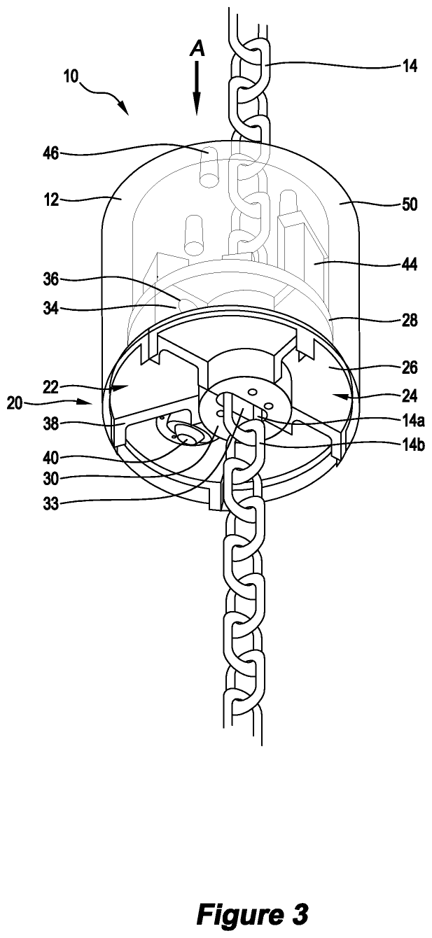

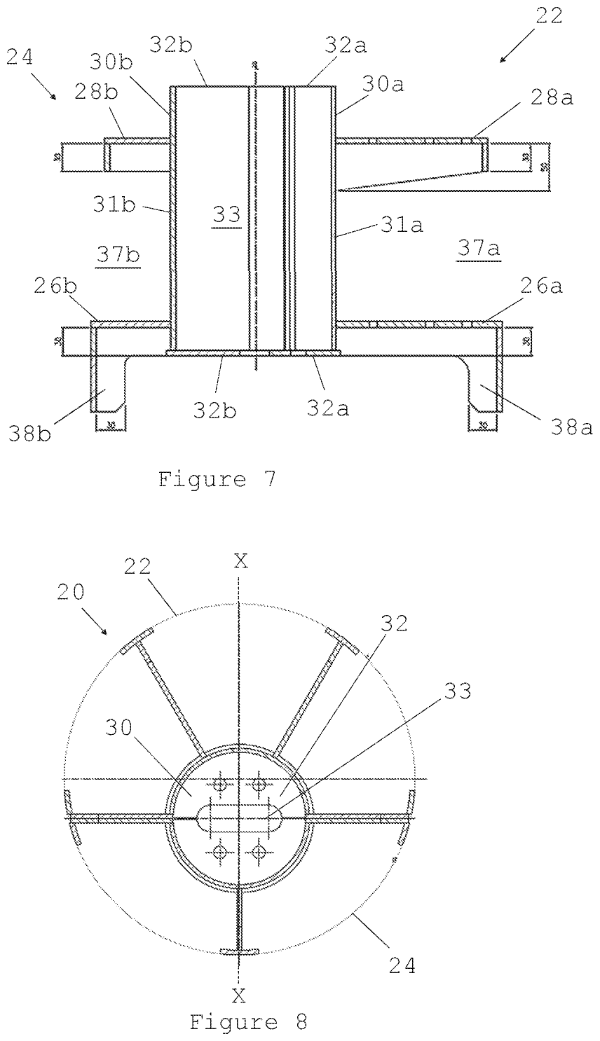

As shown in FIG. 8, a slot 32 extends through the central hub 30 and both tiers 26, 28 of the mounting arrangement 20. The slot 32 is located centrally of the central hub 30. As shown in FIGS. 2 and 3, the central slot 32 is configured for receipt of a chain link 14a rotationally orientated 90 degrees out of phase with the profile of an adjacent chain link 14b such that the adjacent chain link 14b is prevented from passing through the central slot 32.

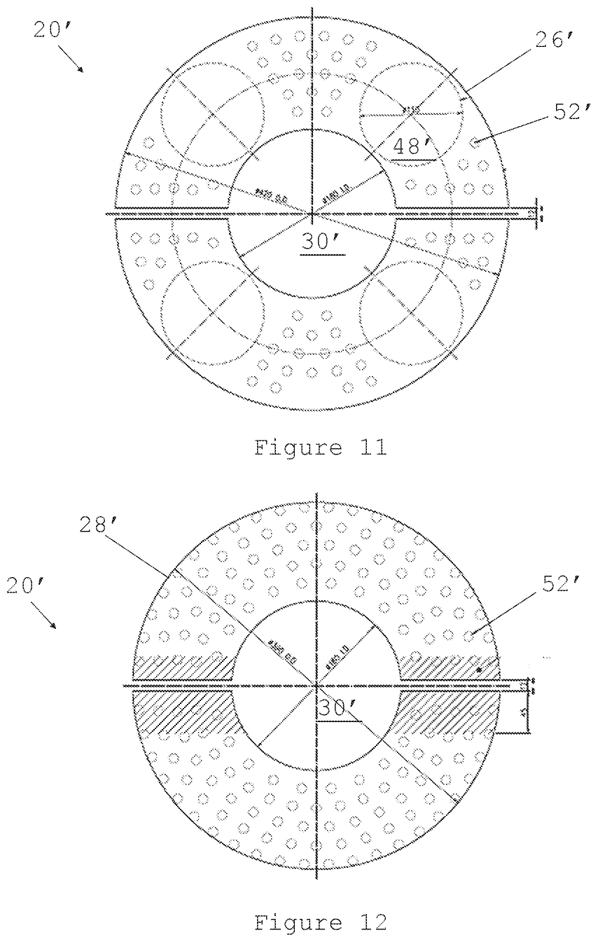

FIGS. 8-10 show that the central hub 30 is offset with respect to a central axis defined by the overall circular shape of assembled mounting arrangement 20. This arrangement increases the available surface area of the downward facing lower tier 26, thereby enabling mounting of large items of monitoring equipment. This offset arrangement of the central hub 30 is to be contrasted with the symmetrical arrangement of central hub 30′, as illustrated in the alternative embodiment of the mounting arrangement 20′ shown in FIGS. 11 and 12.

In the embodiment described in relation to FIGS. 2 to 12, the lower tier 26, 26′ can have a diameter of about 450 mm. The upper tier 28, 28′ can have a diameter of about 420 mm. The central hub 30, 30′ of the mounting arrangement 20, 20′ can have a diameter of about 170 mm.

Turning back to FIG. 4 the polymeric shell 50 provides an outer shell to the device 10 which is selectively removeable. The shell 50 is illustrated to have a hollow cylindrical shape having a lower end 50a and an upper end 50b. The shell 50 defines an inner cavity 50c for receiving the mounting arrangement 20 and sensing equipment. The cavity 50c extends from the lower end 50a of the shell to the upper end 50b of the shell 50.

The lower portion of the cavity 50c proximate the lower end of the shell 50 has an opening with a diameter sized to enable an interference fit with the mounting arrangement 20; and a length sufficient to accommodate the mounting arrangement 20 therein.

A middle section 50d is situated axially between the lower section 50a and the upper section 50b and communicates therewith. The middle section 50d has a diameter greater than the diameter of the lower section 50a to enable the monitoring equipment to be housed therein.

The upper section 50b has an upper opening 50e sufficient in size to allow the chain link 14a of the chain 14 to pass therethrough.

As can be appreciated, when the mounting arrangement 20 is fitted to the lower section 50a of the outer shell 50 the slot 32 communicates with the middle 50d and upper sections 50b of the shell 50 such that the chain 14 can be passed through the housing 12 from the lower end 50a to the upper end 50b. This allows the weight of the object 18 being hoisted by the crane 16 to bypass the housing 12 altogether and be transferred directly to the crane 16 without being transferred through the housing 12.

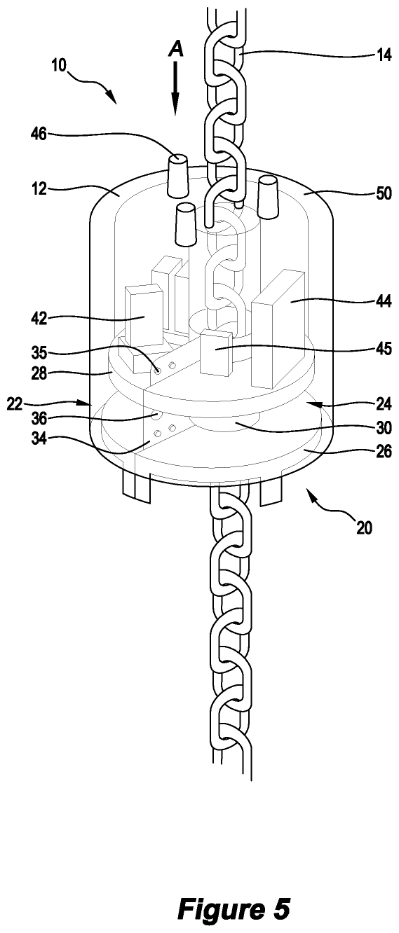

The monitoring equipment is best shown in FIGS. 4 and 5 and comprises electronic components including a camera 40, lithium-ion battery 42, a controller 44 and one or more antennae 46 (three are shown).

The camera 40 is mounted to the lower tier 26. The camera 40 is downward facing thereby providing a view of the area directly below the device 10. For example, as shown in FIGS. 2-4, the camera 40 can be a hemisphere camera such as the AXIS™ M3058-PLVE Network Camera.

In the embodiment the mounting arrangement 20′ shown in FIGS. 11 and 12, the lower tier 26 has multiple holes 48 to accommodate multiple downward facing cameras 40. These can provide a broader view of the area below device 10, for example, the cameras 40 can vary in viewing angle (for example, at least one camera 40 can comprise a fisheye lens) and/or imaging resolution. Two or more cameras 40 can be arranged to provide a stereographic view.

In an embodiment (not shown), there are one or more upward facing cameras 40 provided. These can be positioned, for example, on an uppermost surface of the outer shell 50. Together with the at least one downward facing camera 40, the plurality of cameras 40 provide a view above and below the device 10.

The lithium-ion battery 42 and the controller 44 are mounted to the upper tier 28. The battery 42 can comprise several discrete units, as shown. Generally, the battery 42 should be suitable for providing sufficient energy to the electronic components to avoid recharging or replacement during a typical period of continuous use of the crane 16. For example, sufficient for use during an entire day. The individual battery units can have a common form factor for interfacing with a receptacle positioned on the mounting arrangement 20, to enable ease of installation and removal.

The controller 44 comprises one or more processors (e.g. CPUs although other processing units are envisaged, for example, a field-programmable gate array). Additionally, the controller 44 comprises a memory, typically including a volatile memory and non-volatile memory, the memory interfaced with the one or more processors. The controller 44 further comprises a network interface configured for providing at least wireless communication functionality (in certain implementations, wired communication functions can be incorporated). The network communication interface is interfaced with antennae 46 to enable wireless communications with one or more base stations (not shown). The controller 44 can be embodied, at least the one or more processors and the memory, in a unitary module (e.g. as a microcontroller).

The one or more antennae 46 are mounted to the uppermost surface of the outer shell 50. In an embodiment, at least one antenna 46 is associated with a first wireless protocol and at least one other antenna 46 is associated with a second wireless protocol. Additionally, at least one antenna 46 is intended for communication with a first base station (not shown) mounted to crane 16 and at least one antenna 46 is intended for communication with a remotely located second base station. For example, a shorter range wireless protocol can be preferred for communicating with the first base station whereas a longer range protocol is preferred for communicating with the second base station.

The controller 44 is interfaced with the camera 40 (or each camera 40 where applicable) and configured to control the camera 40 to obtain images of the camera's viewing area, which can be stored in the memory. The images can also be communicated, in real-time (i.e. shortly after capture) or later, to one or more base stations via wireless communication.

Additional components can be included, for example shown as feature 45 in FIG. 5. These can be electronic components, for example, an environmental sensor, such as selected from one or more: altimeters, electronic compass, Global Positioning System (GPS) receivers, Light Detection and Ranging (LIDAR) sensor, Sonar, Infra-Red cameras, spectrometers, environmental sensors, and scanners.

FIGS. 4 and 5 show a plurality of batteries 42. These batteries 42 can be removeable such as to allow easy replacement of one or more batteries 42 with replacements. For example, this can be useful as it allows charging of one set of batteries 42 while another set is in use. In another example, the same batteries 42 are removed, charged, and returned between uses (for example, overnight).

As mentioned, in this embodiment, the shell 50 is releasably secured to the mounting arrangement 20 which advantageously enables access to the electronic components without removing the entire device 10 from chain 14. The shell 50 can be releasably secured to the chain 14 separately from the mounting arrangement 20 (for example, above the arrangement 20) using a locking pin or other releasable securing means (not shown).

Although not shown in the figures, the device 10 can comprise one or more environmental sensors. These can be selected from any one or more of: noise sensor; dust sensor; temperature sensor; wind sensor; Light Detection and Ranging (LIDAR) sensor; altimeter; Global Positioning System (GPS) sensor; and accelerometer. The camera 40 can also be considered an environmental sensor. These can be mounted to mounting platform 20 or elsewhere on the device 10 (e.g. on shell 50. The controller 44 is typically interfaced with these one or more environmental sensors such as to control the sensors to make measurements, which are then communicated to the controller 44 for storage in memory and/or communication to one or more base stations.

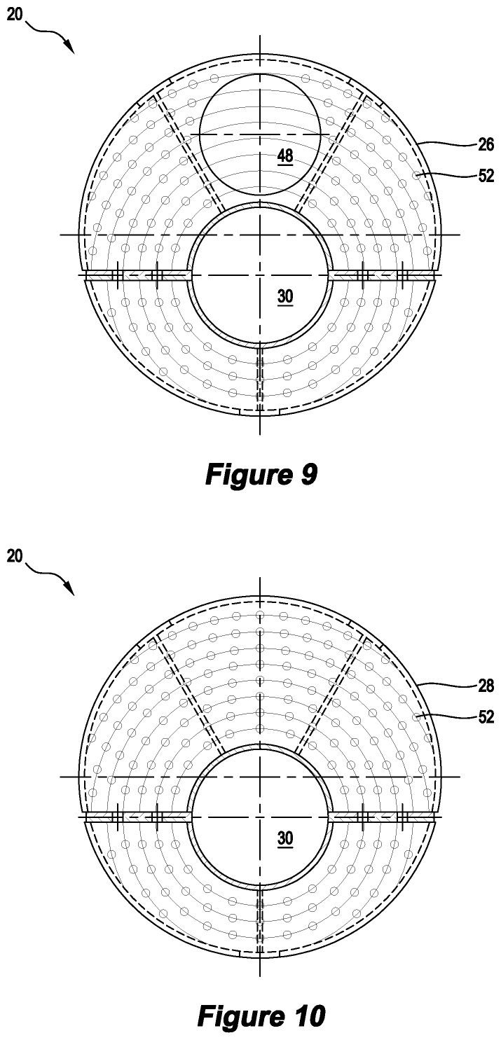

As previously mentioned, the lower tier 26′ shown in FIG. 11 comprise four holes 48′ for routing the camera therethrough. The holes 48′ are circumferentially spaced apart around the central hub 30′ and each have a diameter of about 110 mm. Whilst in the embodiment shown in FIG. 9 the lower tier 26 has one hole 48, it is also envisaged that the lower tier 26 may have more or fewer holes depending on preference for number of holes and/or the size of the lower tier 26.

In the embodiment described in relation to FIGS. 9 and 10, the lower tier 26 has a diameter of about 420 mm.

FIG. 9 shows the lower tier 26. The lower tier 26 has a diameter of about 390 mm and comprise a plurality of holes 52 to allow heat transfer (convection) therethrough. These holes 52 have a diameter of about 10 mm.

FIG. 10 shows the upper tier 28. The upper tier 28 has a diameter of about 390 mm and also comprise a plurality of holes 52 to allow heat transfer (convection) therethrough. These holes 52 have a diameter of about 10 mm. The holes 52 are desirable because the monitoring equipment generates heat which needs to be effectively dissipated to avoid damaging the monitoring equipment. The central hub 30 of the mounting arrangement shown in FIGS. 9 and 10 has a diameter of about 180 mm.

The lower and upper tiers 24, 26 comprise a plurality of holes 52 to allow heat transfer therethrough (via convection). These holes 52 have a diameter of about 10 mm. The holes 52 are desirable because the monitoring equipment generates heat which needs to be effectively dissipated to avoid damaging the monitoring equipment.

In the embodiment described in relation to FIGS. 11 and 12, the lower tier 26′ has a diameter of about 420 mm.

The central hub 30′ of the mounting arrangement shown in FIGS. 11 and 12 has a diameter of about 180 mm.

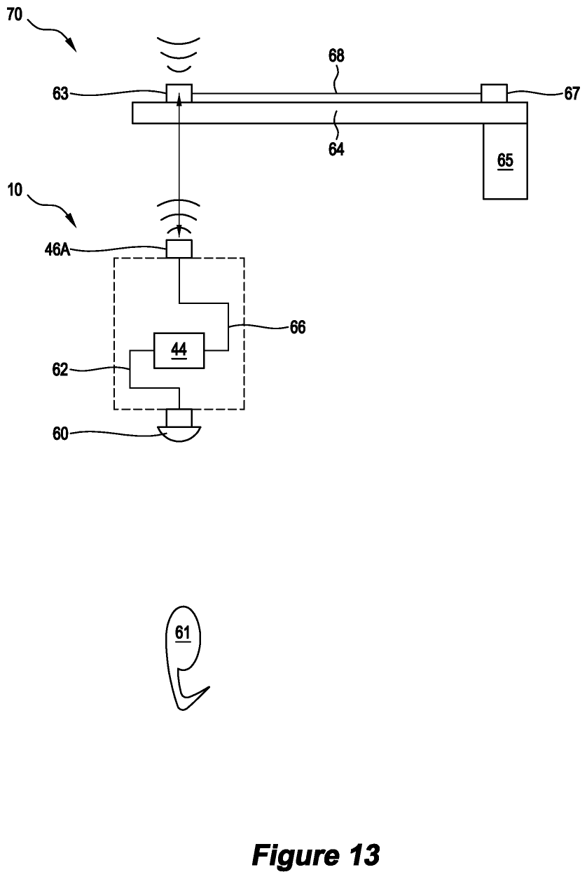

Referring to FIG. 13, a visualisation system 70 is shown in which the device 10, according to an embodiment, comprises hook camera 60 arranged to provide a line-of-sight view of an area or object under a hook 61 of the crane 16.

In this embodiment, the hook camera 60 is located remotely to the housing 12 of the device 10 and arranged to view directly below the hook 61; in this embodiment, the hook camera 60 is electrically coupled to controller 44 via first data cable 62 (it should be noted that data cable 62 typically provides electrical power to the hook camera 60 as well as a data communication channel).

In another embodiment, the hook camera 60 corresponds to one of the cameras 40 mounted to the mounting arrangement 20. In either case, the hook camera 60 is controllable by the controller 44 to obtain images (which may correspond to a video) of the area directly below the hook 61.

A wireless data receiver 63 is arranged at a distal end of a jib 64 of the crane 16, that is, distal with respect to a cab 65. The wireless data receiver 63 is arranged to have a reliable line-of-sight to a complementary antenna 46A located on the upper surface ( ) of shell 50. In use, the controller 44 is configured to communicate with the wireless data receiver 63 via the complementary antenna 46A. The controller 44 is connected to the antenna 46A via a cable 66 (it should be noted that cable 66 typically provides electrical power to the antenna 46A as well as a data communication channel).

As shown in FIG. 13, the wireless data receiver 63 is itself electrically coupled to a receiver unit 67 located proximate the cab 65 via a second data cable 68. It is intended that the cab 65 comprises viewing means (e.g. an electronic digital display) for presenting to a cab operator the captured images (or video) obtained by the hook camera 60. The receiver unit 67 and viewing means can be implemented using suitable computing devices known in the art.

The arrangement of FIG. 13 can advantageously provide a stable and low latency data connection between the hook camera 60 and receiver unit 67. Unlike a purely wireless communication between the hook camera 60 and the receiver unit 67 located within or in proximity to cab 65, the arrangement of FIG. 13 is not prone, and may entirely avoid, failures of data communication due to obstacles which may transiently enter into the line-of-sight between the hook 61 and the cab 65 during normal operation of the crane 16.

Additionally, the arrangement can advantageously reduce latency compared to a purely wireless communication by maximising wired data communication signal paths. An advantage of including a wireless data communication path between device 10 and jib 64 is that this distance is subject to considerable change during normal crane use, due to raising and lowering of connected loads. A wireless communication therefore avoids problems with slackening of a wired data cable.

Overall, the arrangement of FIG. 13 can advantageously allow for a real-time, low (even undetectable by a crane operator) latency, video feed between the hook camera 60 and the receiver unit 67. Thus, a crane operator may advantageously feel comfortable relying on the display of the video feed for assisting the crane operator in operating the crane 16.

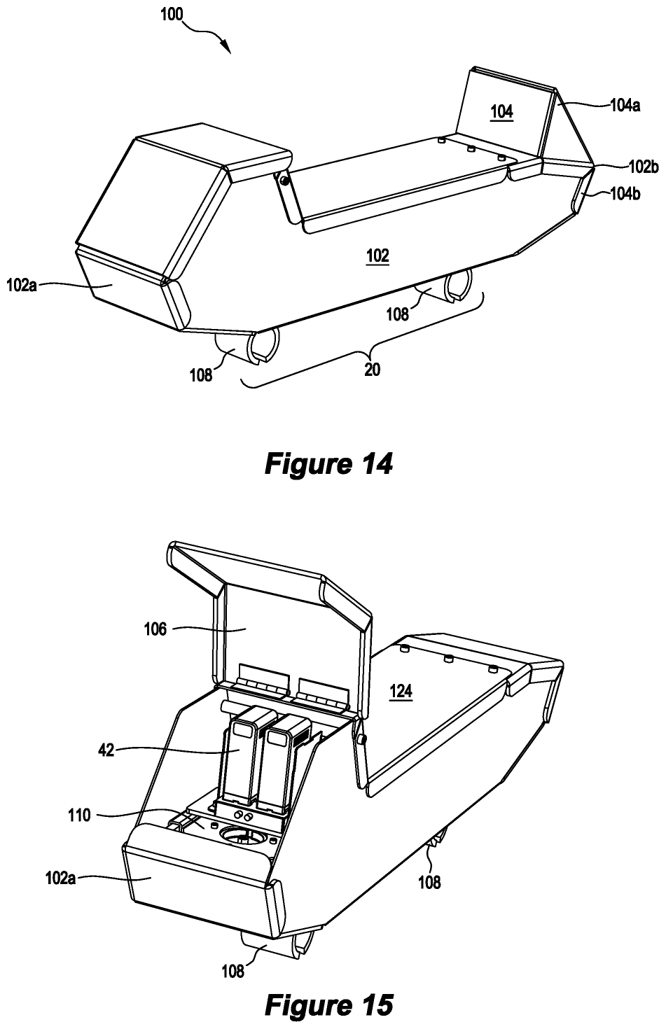

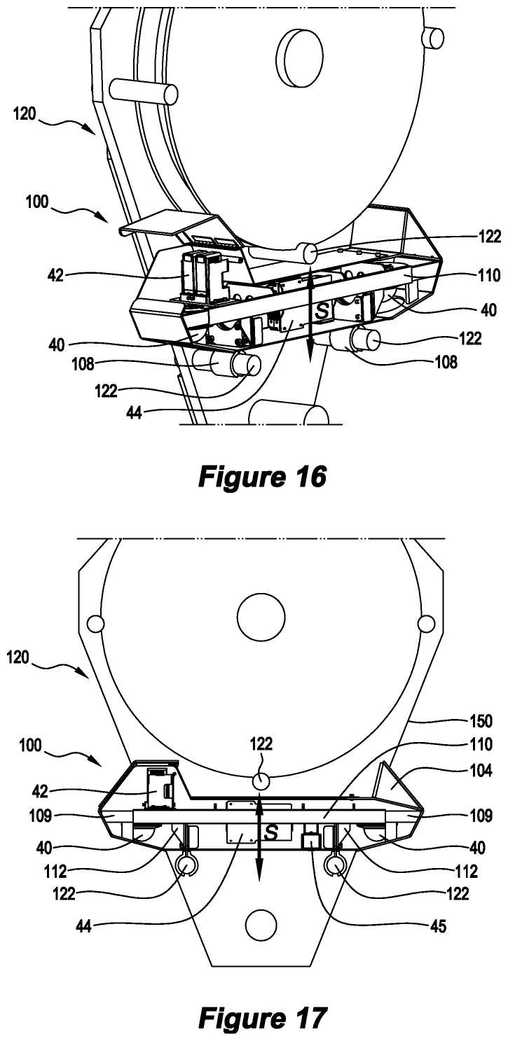

FIGS. 14 to 21 show a device 100 for monitoring a construction site according to an alternative embodiment of the invention. The device 100 comprises a housing 102 for containing monitoring equipment. The housing 102 is configured to be releasably secured to a hook block 120 of the hoist of a crane 16, for lifting an object 18 as shown in FIGS. 16 and 17.

FIG. 14 illustrates the elongate, hollow housing 102 of the device 100 having a first end 102a providing access to the monitoring equipment therein and a second opposing end 102b which is tapered for inserting and locating the housing 102 within the hook block 120. The housing 102 is made from a 3 mm sheet steel with end caps made from 6 mm plate.

Also illustrated in FIG. 14 located at the end 102b of the housing 102 is a locking element 104. The locking element 104 is illustrated as a triangular block formed from sheet steel. The locking element can be attached to the housing 102 before or after the housing 102 is positioned within the hook block 120 to lock the housing 102 in position. In the embodiment shown, the locking element 104 is couplable to a top wall 124 (see FIG. 15) of the housing 102 at the second end 102b. The locking element 104 acts as a detent which limits movement of the housing 102 with respect to the hook block 120, as will be described in more detail later in the specification.

In some embodiments (not shown) the locking element 104 can be shaped and sized to mimic the first end of the housing 102a and thereby provide additional storage for batteries for monitoring equipment in the second end 102b of the housing 102. In this embodiment the housing 102 is symmetrical. The locking element 104 can provide a tapered surface 104a to avoid collisions. The housing 102 can also be shaped to provide tapered or sloped external surfaces 104b. As the hook block 120 can operate in harsh environments and is typically swinging around as a part of the hoist, collisions can occur. In these situations, the tapered surfaces 104a, 104b can assist in deflecting items away from the housing 102 and preventing the housing 102 from being damaged or caught-up. More importantly, deflecting potential collisions with the housing 102 can protect the monitoring equipment therein and extend the working life of the device 100.

In a similar manner to device 10, the housing 102 of device 100 has a line-of-sight view of the object 18 from the hook block 120 and the weight of the object 18 is transferred along the hoist to the crane 16 without being transferred through the housing 102. This embodiment is particularly useful for tower cranes of load capacity between 100-300 tonnes in which a chain would be too large to accommodate the device 10.

The hook block 120 is an assembly to which the hook 61 is attached. The hook block 120 comprises a pair of triangular steel plates 150 connected to one another in a spaced apart arrangement to define a gap therebetween. The plates 150 are connected together via one or more fastening elements, illustrated in FIG. 16 as pins 122. The hook 61 is disposed within the gap and pivotably attached to both plates 150.

In one specific example, the hook block 120 is about 4.5 tonnes, the plates 150 are about 3 metres in height and 75 mm in thickness, and the gap between the plates 150 is about 450 mm.

The device 100 comprises a mounting arrangement 20 in the form of a pair of clamps 108. Each clamp 108 has a pair of clamping members 108a, 108b (see FIG. 21) that are movable towards each other to clamp to a mounting point, illustrated in FIG. 16 as pins 122 on the hook block 120. In this arrangement, the weight of the object 18 is transferred to the crane 16 without being supported by the housing 102 because the housing 102 is attached to the hook block 120. In other words, the housing 102 does not support the weight of the object 18 being lifted, which provides the same advantages as described in relation to device 10 herein.

As shown in FIGS. 16 and 17, the housing 102 is shaped and sized so as to fit between a space S between the pins 122 within the gap defined by the plates 150. By fitting the housing 102 in such a way, the device 100 utilises the dead space within the hook block 120 whilst also providing a line-of-sight view of the object 18 from the hook block 120—which is located above the object 18 during lifting. In one method of securing the device 100 to the hook block 120, the second end 102b of the housing 102 is insertable through the space S between the pins 120 and the locking element 104 is then secured to the top wall 124 of the second end 102b. In this configuration, the locking element 104 increases depth of the device 100 at the second end 102b such that it is no longer removable through the space S between the pins 120. In effect, the locking element 104 acts as a detent which limits movement of the housing 102 with respect to the hook block 120.

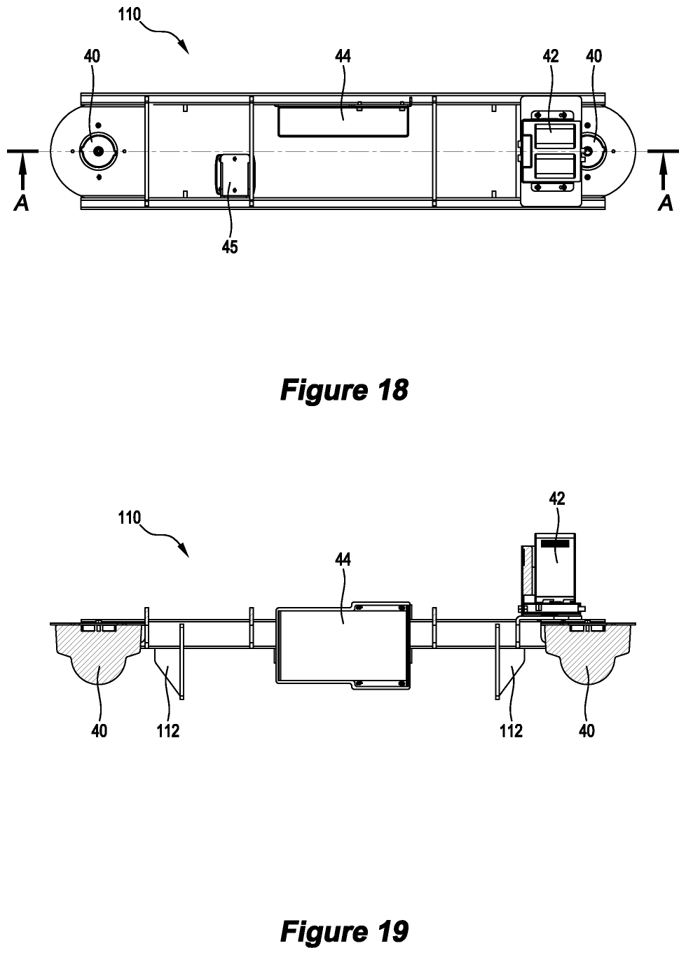

A platform 110, illustrated in FIG. 18, is locatable within the housing 102 for mounting electronic components including cameras 40, batteries 42, a controller 44 and sensors 45. These components may have the same or similar specifications as previously described for device 10 (see illustration in FIG. 16).

As shown in FIG. 15, the housing 102 has an access aperture sealable by a door (106) that is openable to gain access to the batteries 42. This provides ease of access for removal and/or replacement of batteries 42.

The platform 110 comprises a pair of legs 112 (see FIG. 19) that are configured to abut an internal wall of a base 123 of the housing 102 to space the platform 110 from the base 123, shown in FIG. 21.

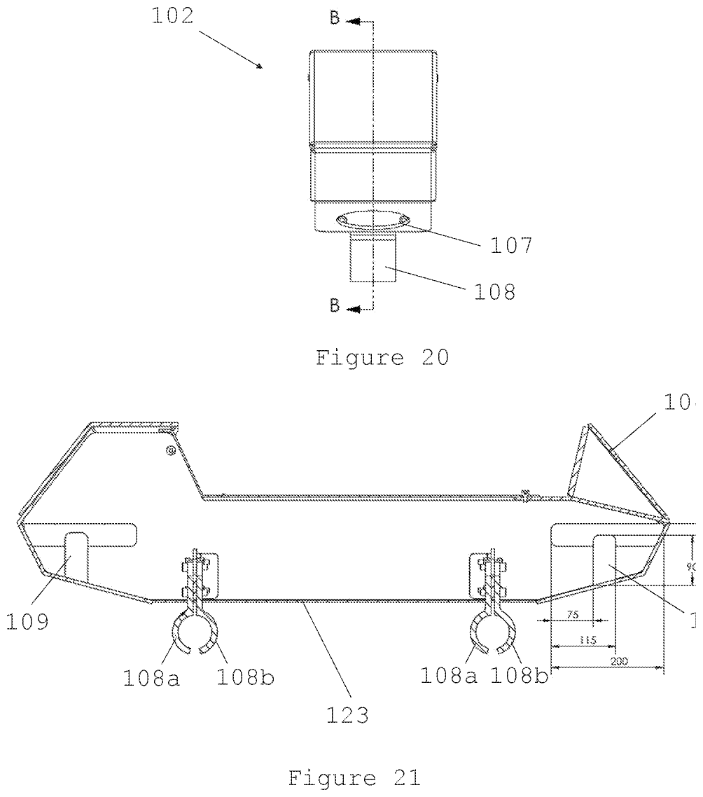

The housing 102 comprises a pair of openings 107, shown in FIG. 20, that are configured to allow the internally located cameras 40 within the housing 102 to have line-of-sight viewing of the object 18 lifted by the crane 16.

The housing 102 comprises a pair of guides 109 which enable the platform 110 to be longitudinally arranged such that the cameras 40 can be aligned with the respective openings 107.

To conclude, the present invention provides a device for monitoring a construction site, the device having a housing for containing monitoring equipment, the housing configured to be releasably secured to a hoist of a crane for lifting an object, such that the housing has a line-of-sight view of the object from the hoist and the weight of the object is transferred directly to the crane without being supported by the housing.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the device and method as disclosed herein.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose.

Terms such as “front” and “rear”, “inner” and “outer”, “above”, “below”, “upper” and “lower” and the like are used as words of convenience to provide reference points and are not to be construed as limiting terms. The terms “vertical” and “horizontal” when used in reference to the device throughout the specification, including the claims, refer to orientations relative to the normal operating orientation of the device.

Also, the various embodiments described above may be implemented in conjunction with other embodiments, for example, aspects of one embodiment may be combined with aspects of another embodiment to realize yet other embodiments. Further, each independent feature or component of any given assembly may constitute an additional embodiment.

1-30. (canceled)

31. A crane mounted device for monitoring a construction site, the device comprising a housing for containing monitoring equipment, the housing configured to be releasably secured via clamping means to a hoist of the crane above an object to be lifted, the housing locatable about the hoist to have line-of-sight along the hoist and to the object to be lifted wherein, in use, a weight of the housing is wholly supported by the hoist via the clamping means while the weight of the object is transferred via the hoist directly to the crane, such that the weight of the object bypasses the housing.

32. The device of claim 31, wherein the housing is configured to be releasably secured to a hoist line of the hoist of the crane.

33. The device of claim 32, wherein the housing is configured to allow the hoist line to extend through the housing.

34. The device of claim 31, wherein the housing comprises a mounting arrangement having clamping means, the clamping means comprising a first clamping element and a second clamping element, the first clamping element being configured to engage the second clamping element to trap and retain a portion of the hoist line therebetween.

35. The device of claim 34, wherein the first and second clamping elements are configured to be interconnected in engagement with the hoist line.

36. The device of claim 34, wherein the mounting arrangement provides an aperture for receiving the hoist line.

37. The device of claim 36, wherein the aperture is a slot configured for receipt of a chain link of the hoist line and orientated such that an adjacent chain link of the hoist line is prevented from passing therethrough.

38. The device of claim 34, wherein the housing comprises an outer shell that is releasably secured to the mounting arrangement.

39. The device of claim 38, wherein the outer shell covers the mounting arrangement.

40. The device of claim 39, wherein the outer shell is made from a polymeric material or a metallic material.

41. The device of claim 31, wherein the housing is configured to be releasably secured to a hook block on the hoist of the crane.

42. The device of claim 41, wherein the housing comprises a mounting arrangement having a first clamping element and a second clamping element.

43. The device of claim 42, wherein the first and second clamping elements are configured to engage with discrete mounting points of the hook block.

44. The device of claim 31, wherein the housing comprises at least one internal platform for supporting the monitoring equipment.

45. The device of claim 44, wherein the monitoring equipment comprises an electronic component selected from at least one of: an environmental sensor; a battery; a controller; a transmitter; and a receiver.

46. The device of claim 45, wherein the electronic component includes the environmental sensor selected from at least one of: a noise sensor; a dust sensor; a temperature sensor; a wind sensor; a Light Detection and Ranging (LIDAR) sensor; an altimeter; a Global Positioning System (GPS) sensor; an accelerometer; and a camera.

47. The device of claim 46, wherein the environmental sensor is a camera.

48. The device of claim 47, wherein the camera is downward facing thereby, in use, providing a view of an area directly below the device.

49. The device of claim 45, wherein the electronic component includes the battery, the battery comprising a plurality of discrete units.

50. The device of claim 45, wherein the electronic component includes the transmitter and the receiver, the transmitter and the receiver enabling wireless communications with one or more base stations.
